(19) United States
(12) Patent Application Publication
(10) Pub. No.: US 2023/0264573 A1
(43) Pub. Date: Aug. 24, 2023

(54) SYSTEMS AND METHODS FOR VEHICLE CHARGING

(71) Applicant: Dana Heavy Vehicle Systems Group, LLC, Maumee, OH (US)

(72) Inventors: David HEIN, Sterling Heights, MI (US); Marc DAIGNEAULT, Montreal (CA); Hong YANG, Rochester Hills, MI (US)

(21) Appl. No.: 18/158,345

(22) Filed: Jan. 23, 2023

Related U.S. Application Data
(60) Provisional application No. 63/268,257, filed on Feb. 18, 2022.

(51) Int. Cl. B60L 3/04; H02J 7/00; B60L 3/00; H02B 1/56

(52) U.S. Cl. CPC B60L 3/04; H02J 7/00304; H02J 7/007192; H02J 7/00714; B60L 3/0069; H02B 1/56

(57) ABSTRACT

Methods and system are provided for protection against a short-circuit while charging an electric vehicle. In one example, a system for controlling charging of a vehicle includes a charge coupler and an integrated protection control box (IPCB). The IPCB including a fuse device, at least one temperature sensor for monitoring a temperature of the fuse device, a cooling system for cooling the fuse device, and a charging interface connector coupled to the at least one temperature sensor.

### CROSS REFERENCE TO RELATED APPLICATIONS

The present application claims priority to U.S. Provisional Application No. 63/268,257, entitled “SYSTEMS AND METHODS FOR VEHICLE CHARGING”, and filed on Feb. 18, 2022. The entire contents of the above-identified application are hereby incorporated by reference for all purposes.

### TECHNICAL FIELD

The present document relates to charging of electric vehicles.

### BACKGROUND AND SUMMARY

In order to reduce the charging time for electric vehicles, DC fast charge stations have been created with capabilities for currents up to 500 amps and increasing to over 2,000 amps in the future. With these very high charging currents, electric vehicle systems may demand methods and systems to efficiently transfer the energy from the charging station to the high voltage batteries of the electric vehicles without degrading the vehicle or the charging station. To charge smoothly, protection systems may be included that mitigate transmission of current spikes to the electric vehicle in the event of a short circuit. Due to the large stored energy and low resistance wiring and connections in the vehicle, short circuit currents can reach 200,000 amps with voltages at 1,000 volts. When subject to such large short circuit currents, vehicle components, including charging infrastructure, may become degraded due to generation of large quantities of heat that may exceed a heat tolerance of the components. Thus, development of a strategy to provide efficient charging as well as short circuit circumvention may be desirable.

In one example, the issues described above may be addressed by a system for controlling charging of a vehicle, including a charge coupler and a control box electrically coupled to the charge coupler. The control box may include a fuse device, at least one temperature sensor for monitoring a temperature of the fuse device, a cooling system for cooling the fuse device based on a signal from the temperature sensor, and a charging interface communicatively coupled to the temperature sensor, wherein the fuse device is configured to be current limiting under a short circuit condition to mitigate an overcurrent event. In this way, protection of the vehicle against large short circuit currents may be provided at the point of connection to the DC charging current input and the protection may be adjusted based on the type of charging provided to the vehicle.

As one example, temperature sensing of the fuse device may allow for detection and control of charging current based on the fuse device temperature. A control box [herein referred to as an integrated protection control box (IPCB)] may mitigate transmission of short circuit currents to a vehicle with low power loss and allow for bi-directional current transfer. Coordination between the fuse device, active cooling, and temperature detection may allow for both reliable operation with low power loss as well as protection of fault conditions. Further, the IPCB may protect against short-circuits without inhibiting vehicle-to-grid energy transfer.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1 shows a schematic diagram of a charging configuration for an electric vehicle including an integrated protection control box (IPCB).

FIG. 2 shows a graph plotting peak let-through for a high speed fuse.

FIG. 3 shows an example of a flowchart of a method for controlling charging current using an IPCB.

FIG. 4 shows a graph of peak current as a function of prospective DC current for fuses of current ratings from 250 A to 800 A.

FIG. 5 shows a graph of a temperature correction factor relative to ambient temperature.

FIG. 6 shows a graph of a cooling air correction factor relative to air speed.

FIG. 7 shows an exemplary embodiment of an IPCB.

### DETAILED DESCRIPTION

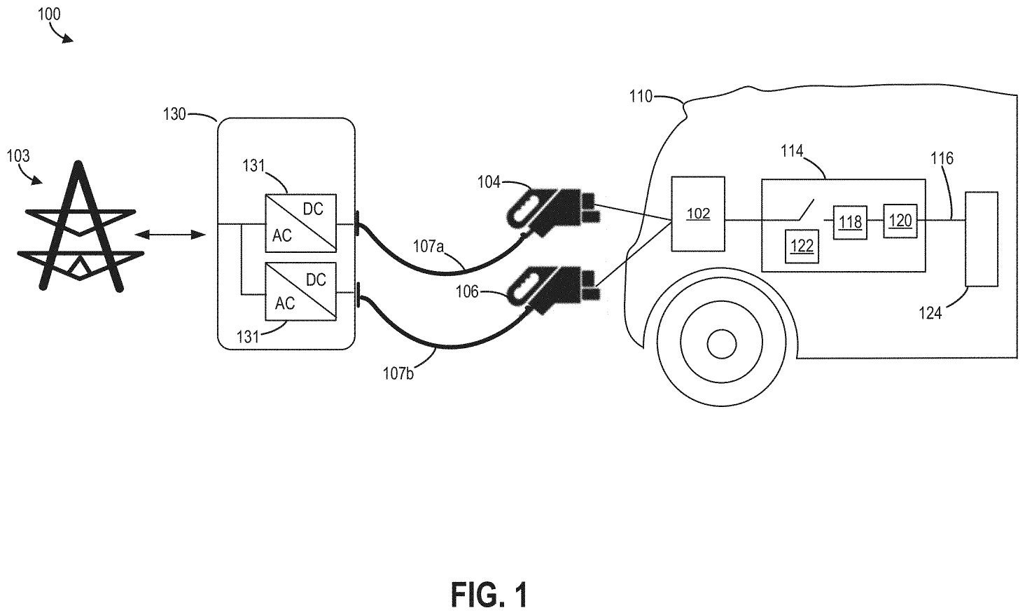

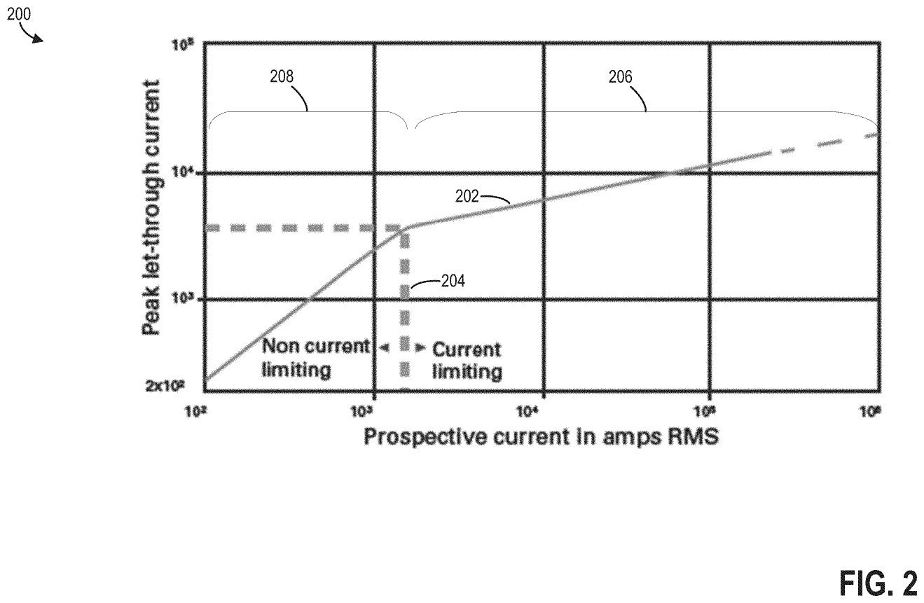

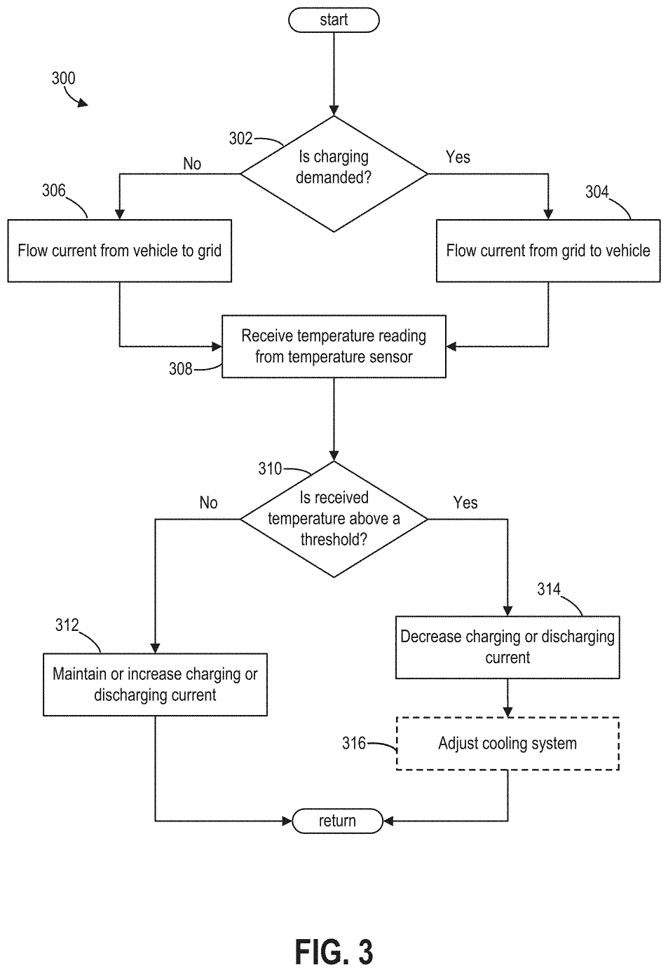

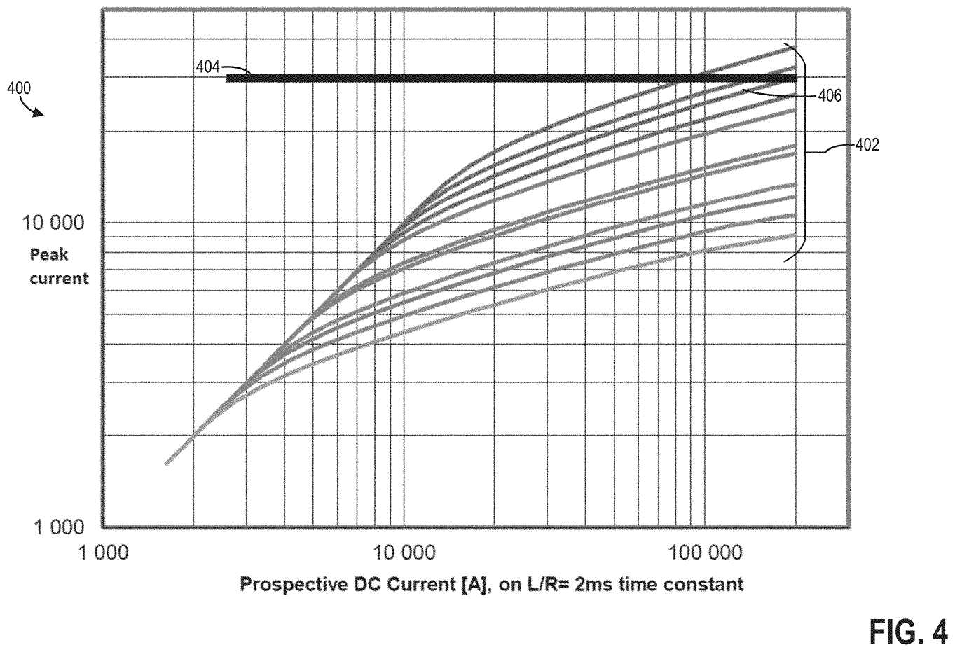

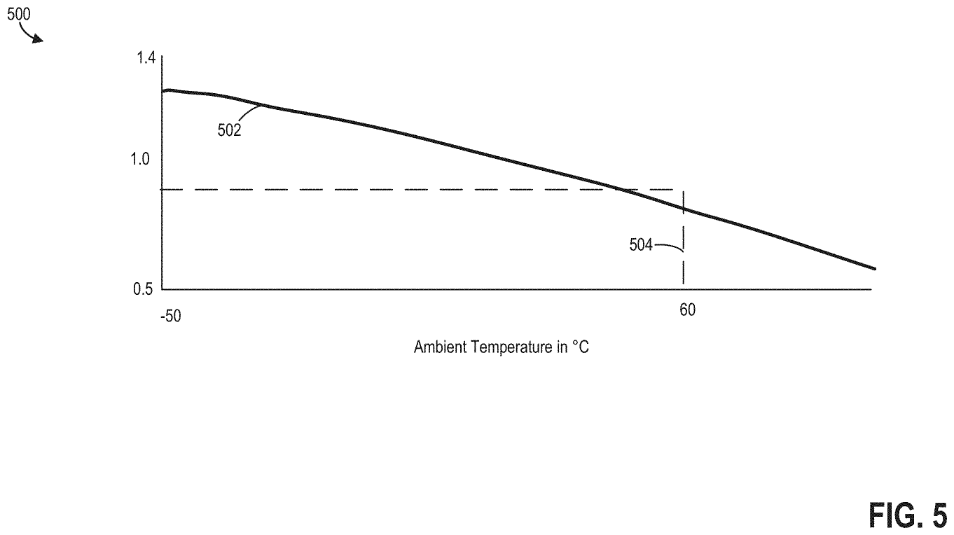

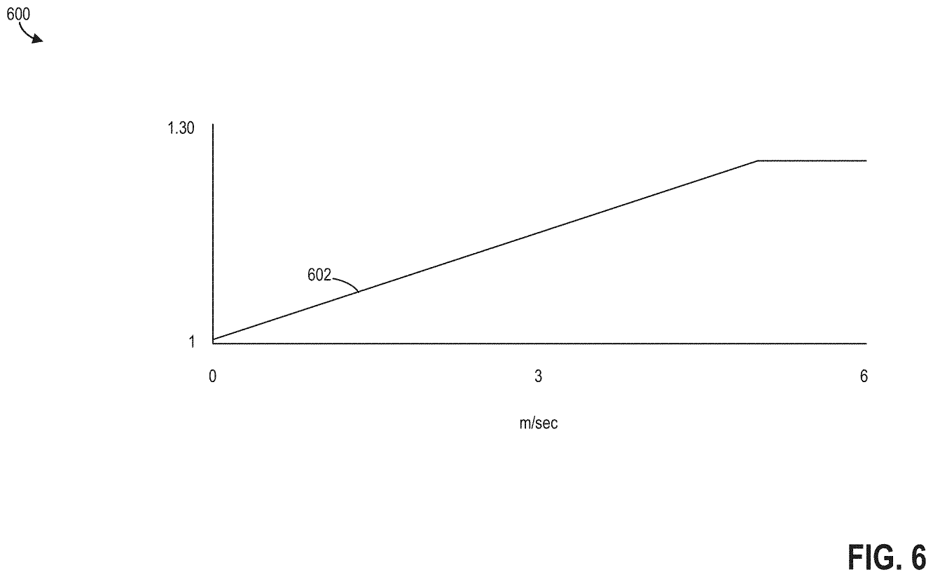

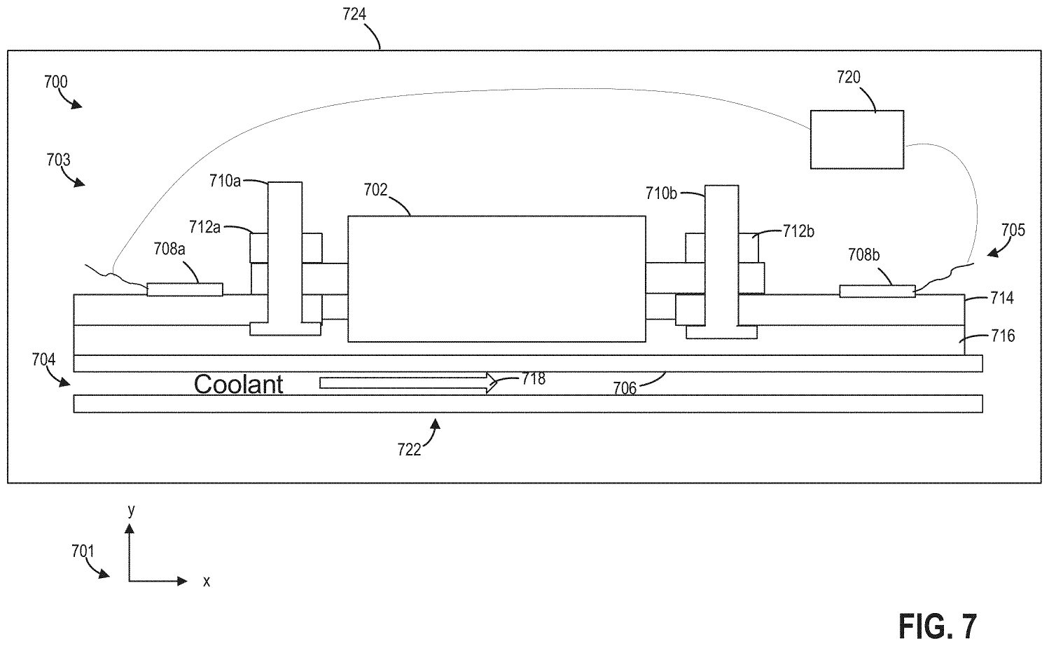

The following description relates to systems and methods for short circuit protection of a charge coupler for an electric vehicle such as the charge coupler of FIG. 1. An IPCB, including a fuse device, cooling system, and temperature sensor, may provide short circuit protection for the electric vehicle during charging events. Properties of the fuse device are plotted in graphs shown in FIG. 2 and FIG. 4. The fuse device may operate without degrading under external temperatures as high as 85° C. A permissible current load for the fuse device may be calculated using a temperature correction factor and cooling air correction factor as plotted in FIGS. 5-6. An embodiment of the IPCB is shown in FIG. 7, including a cooling plate for temperature management and a charging interface connector. The charging interface connector may adjust a charging or discharging current flowing to and/or from the IPCB. An example of a method for adjusting the charging current is shown in FIG. 3.

Turning now to FIG. 1, a schematic diagram of a charging configuration 100 for charging a DC output 116 to a high voltage battery 124. In an exemplary embodiment, DC output 116 may be an electric vehicle 110. However, other DC outputs such as battery powered generators have been considered within a scope of the disclosure. Charging configuration 100 may include an energy grid 103. In some examples, energy delivered by energy grid 103 may be at least partially derived from renewable energy sources such as wind or solar. Energy grid 103 may be electrically coupled to a vehicle charging station 130. Internally, the vehicle charging station 130 includes AC to DC converters 131 to convert energy from electric vehicle 110 to energy grid 103 or from energy grid 103 to electric vehicle 110 to charge electric vehicle 110.

Vehicle charging station 130 electrically couples energy from energy grid 103 to electric vehicle 110 through a first wire 107a and high voltage charge coupler (HV CCS) 104 and/or through a second wire 107b and a high voltage megawatt charge coupler (HV MCS) 106. In one example, HV CCS 104 may be selected when electric vehicle 110 is a personal electric vehicle while HV MCS 106 may be selected when electric vehicle 110 is a commercial sized electric vehicle such as a large truck or bus. HV CCS 104 and/or HV MCS 106 may be electrically coupled to the DC output 116 via a charge coupler 102. Charge coupler 102 may connect to an IPCB 114.

IPCB 114 may be configured to prevent short circuit current spikes from reaching DC output 116. IPCB 114 may include a fuse device 118, a cooling system 120 and a charging interface connector 122. Short circuit current spikes can be caused by degradation of AC to DC converters 131 internal to the vehicle charging station 130 or may also be caused by a break in first wire 107a or second wire 107b. Further, IPCB 114 may be configured to allow current to flow from energy grid 103 to DC output 116 or from DC output 116 back to energy grid 103. Criteria for selection of the fuse device for IPCB 114 are discussed below with respect to FIGS. 2-6. An exemplary configuration of IPCB is discussed further below with respect to FIG. 7.

A high speed fuse may act as a current limiting device and may be used as a fuse device for an IPCB, such as IPCB 114 of FIG. 1. When a current flowing through the high speed fuse is above a threshold current, the high speed fuse may be current limiting and reduce a peak let-through short-circuit current of the high speed fuse, thereby reducing thermal and mechanical forces imposed on equipment upon exposure to a short-circuit if the short-circuit occurs. For example, the short-circuit current may be reduced to a level within a rated tolerance of the charging equipment. The charging equipment may refer to any of the components electrically coupled to the DC output 116 including: charge coupler 102, first wire 107a, second wire 107b, HV CCS 104, HV MCS 106, and AC to DC converter 131.

Turning now to FIG. 2, a graph 200 is shown including a peak let-through curve for a high speed fuse showing a peak let-through current as a function of prospective current (IP) in amps as root-mean-square (RMS) values. The high speed fuse may be a fuse device of an IPCB, such as fuse device 118 of IPCB 114 of FIG. 1. Prospective current is a current that would flow through the circuit if the fuse device was not included in the system and is shown on the x-axis. The peak let-through current, as plotted relative to the y-axis, is a maximum current that is allowed to flow through the high speed fuse. Plot 202 may be characteristic of a peak let-through curve for the high speed fuse. The peak let-through current may vary as a function of prospective current at a first slope for lower prospective current as indicated by bracket 208. Above a prospective current designated by line 204 (e.g., the threshold current), plot 202 peak let-through current may begin to change as a function of prospective current at a second slope. The section of plot 202 corresponding to the second slope is indicated by bracket 206. The first slope may be higher than the second slope. A decrease in slope from the first slope to the second slope may result from a current-limiting effect of the high speed fuse.

The current-limiting effect of the high speed fuse may be from a fuse element of the high speed fuse configured to heat or melt when an overcurrent is passing through the high speed fuse causing the resistance of the fuse to increase. In this way, the high speed fuse prevents the current spike from being transmitted through the high speed fuse. Graph 200 shows a threshold magnitude of prospective current (IP) relative to a fuse's peak let through current is demanded before the current-limiting effect may be realized for a fuse with a specific normal current rating (IN). The fuse device may be current limiting for the current input range expected for a short circuit condition.

A high speed fuse may be selected to protect HV CCS type 1 and type 2 connections (e.g., a connection between HV CCS 104 and DC output 116 via charge coupler 102 as shown in FIG. 1) from an external short circuit condition. Further, the high speed fuse may be rated for a characteristic threshold peak current and a threshold I²T rating. The I²T rating for a fuse provides a function to relate an amount of current (I) to a length of time (T) required to start a fuse opening, specifically Current*Current*Time=FT. With a known current and a known I²T rating, a time demanded to start opening the fuse can be calculated. In one example, the charging equipment allowed peak current may be 30 kA and the threshold I²T rating may be 2.5 MA²s and the high speed fuse may be chosen to allow a peak current less than 30 kA and an I²T (e.g., thermal energy resulting from current flow) of less than 2.5 MA²s. Turning now to FIG. 4, graph 400 shows peak current as a function of prospective DC current. Plots 402 correspond to peak currents of high speed fuses in a range from 250 A to 800 A. Line 404 corresponds to a threshold peak current equivalent to 30 kA. Plots 402 falling below line 404 may meet the peak current demand for a fusing device in an IPCB, such as IPCB 114 of FIG. 1. In addition to a threshold peak current, a high speed use selected for a high speed fuse device may be chosen to meet a desired I²T rating and permissible current load as described further below.

Table 1 below shows I²T rating for fuses having a voltage rating of 1000 Vdc and in a range of current ratings from 250 A to 800 A. Each fuse may correspond to plots shown in FIG. 4. Fuses with lower current ratings may have lower I²T ratings and as shown in table 1 for ratings between 250 A and 630 A correspond to plots 402 of FIG. 4. As shown in table 1, high speed fuses in a range from 250 A to 800 A will have lower I²T ratings than medium or low speed fuses. For applications where equipment protection is demanded, a threshold I²T rating may be specified by the equipment. The threshold I²T rating is a maximum I²T rating of the fuse that can be allowed and still prevent significant system degradation. FIG. 4 and table 1 demonstrate a 630 A fuse may satisfy the desired properties for the fusing device in the IPCB. Trace 406 of graph 400 corresponds to a 630 A high speed fuse and falls below line 404. As shown in table 1, a 630 A fuse may have an I²T of 115 kA²s. Further, fuses with current ratings between 250 A and 550 A may also meet the demanded peak current threshold and threshold I²T rating.

TABLE 1
I2T values for fuse selection

| Current | Pre-arcing | Power loss | Power loss |
|---|---|---|---|
| rating In (A) | I2T (A²t) | at 50% In (W) | at In (W) |
| 250 | 6500 | 13 | 65 |
| 280 | 9350 | 14 | 70 |
| 315 | 13000 | 15 | 75 |
| 350 | 16500 | 16 | 80 |
| 400 | 23000 | 17 | 85 |
| 450 | 34000 | 18 | 90 |
| 500 | 48000 | 19 | 95 |
| 550 | 62000 | 20 | 100 |
| 630 | 115000 | 24 | 120 |
| 700 | 160000 | 25 | 125 |
| 800 | 245000 | 26 | 130 |

In addition to a maximum peak current and I²T, a fuse device in an IPCB may operate in an environment where an environmental temperature may reach 85° C. Environmental temperatures and other factors may affect a permissible current load for a fuse. The permissible current load may correspond to an amount of current which may pass through the fuse before it becomes current limiting. Further, the permissible current load may be less than a rated current of the fuse device. Equation 1 below may be used to calculate a maximum permissible continuous RMS load current (e.g., permissible current load, Iᵣₘₛ) for a fuse. In one example, an Iᵣₘₛ of at least 500 A may be desired to meet the current demand of a charging device such as charge coupler 102 of FIG. 1.

Iᵣₘₛ=Iₙ×Kₜ×Kₑ×Kᵥ×Kₐ×Kₓ (1)

Normal current rating (IN or Iₙ) is the rated current of a given fuse link, Kₜ is an ambient temperature correction factor (as discussed below with respect to FIG. 5), Kₑ is a thermal connection factor, Kᵥ is a cooling air correction factor (as discussed below with respect to FIG. 6), Kₐ is a high altitude derating factor, and Kₓ is an enclosure correction factor.

An Iᵣₘₛ for a 630 A fuse operating at 85° C. may be calculated using equation 1. Iₙ may be 630 A, Kₑ may be assumed based on the required bus bar size, Kₐ may be 0.9 at 4000 m, and Kₓ may be assumed to be 0.8 for an uncooled box. Kᵥ may be determined by plot 600 of FIG. 6. Trace 602 shows Kᵥ a as function of air speed. A fusing element in an IPCB may be assumed to be in an enclosure and as such air speed may be 0 m/sec and K, may be 1.

Kₜ may be determined by plot 500 of FIG. 5. Plot 500 includes a trace 502 showing a temperature correction factor as a function of ambient temperature in ° C. The temperature correction factor is greater than 1.0 for temperatures below 20° C. and less than 1.0 for temperatures above 20° C. Based on equation 1, a Kₜ less than one may decrease Iᵣₘₛ. From trace 502, Kₜ is 0.65 at 85° C. The Iᵣₘₛ for a 630 A fuse at 85° C. is calculated to be 300 A. In this way, it may be determined that a 630 A fuse is not suitable for the IPCB unless one of the correction factors of equation 1 can be adjusted. Kₜ may be selected for control using a heatsink and/or a coolant system as described below with respect to FIG. 7. With application of a heatsink and/or coolant system, the ambient temperature of the fusing element in the IPCB may be maintained at 60° C. Line 504 of FIG. 5 may designate the point on trace 502 corresponding to an ambient temperature of 60° C. from which Kₜ is determined to be 0.8. Further, cooling may be supplied external to the box, allowing for Kₓ to be removed from equation 1. In this way, the Iᵣₘₛ for the 630 A fuse at 60° C. is calculated to be 567 A and may be suitable as a fuse for the fusing element in the IPCB.

Turning now to FIG. 7, and an exemplary embodiment of an IPCB 700 is shown. A set of reference axes 701 are provided, including a y-axis, and an x-axis. IPCB 700 may be positioned inside an enclosure 724. Enclosure 724 may surround IPCB 700 and prevent cooling air from reaching a fuse device 702. In this way, a cooling air correction factor for a fuse device 702 of IPCB 700 may be 1. In one example, fuse device 702 may be a 630 A high speed fuse, as discussed above with respect to FIG. 4. The fuse device 702 may include a plurality of fuse elements. Fuse device 702 may be configured to open (e.g., melt) and thereby preventing flow of electrical current through fuse device 702 if a charging or discharging current passing through fuse device 702 is above a threshold current. Fuse device 702 may be conductively coupled to bus bar 714 and secured by nuts 710a and 710b and spring washers 712a and 712b fastened at opposite sides of fuse device 702 along the x-axis. In one example, opposite sides across the x-axis may refer to a charger side 703 (e.g., left side of FIG. 7 with respect to the x-axis) and a vehicle side 705 (e.g., right side FIG. 7 with respect to the x-axis). Fuse device 702 may allow bi-directional current from a charger input (e.g., HV CCS 104 of FIG. 1) through fuse device 702 to a vehicle output (e.g., DC output 116 of FIG. 1) or in the opposite direction from the vehicle back the charger input.

Temperature sensors 708a and 708b may be thermally coupled to bus bar 714 at opposite sides of fuse device 702 along the x-axis. Temperature sensor 708a may be positioned at charger side 703 of fuse device 702 and temperature sensor 708b may positioned at a vehicle side 705 of fuse device 702. Bus bar 714 may be thermally coupled to fuse device 702. In this way, temperature sensors 708a and 708b may be used in combination or separately to monitor a temperature of fuse device 702. Temperature sensors 708a and 708b may enable a charging current to be adjusted based a monitored temperature of fuse device 702. Temperature sensors 708a and 708b may be communicatively coupled to a charging interface connector 720, and the charging interface may be included in IPCB 700 but spaced away from fuse device 702 bus bar 714. Further, charging interface connector 720 may include a processor and non-volatile memory, configured to store instructions. Charging interface connector 720 may be configured to receive a temperature input from temperature sensors 708a and 708b and in response, modify a charging or discharging current input to IPCB 700 in response to the temperature input. For example, temperature sensor 708a may send a temperature reading above a temperature threshold. In response, the charging interface may decrease the charging current input.

IPCB 700 may further include a cooling system 722 for moderating a temperature of fuse device 702. Fuse device 702 may be cooled by cooling system 722 which may include a thermal pad 716, a cold plate 706, and a cooling chamber 704. In one example cooling chamber 704 may include a coolant tube routed in an area of fuse device 702. In an alternate example, the cooling chamber 704 may be formed as a coolant path between the cold plate 706 and a lower plate of the cooling system 722. Fuse device 702 may sit on thermal pad 716 (e.g., fuse device 702 may be above thermal pad 716 on a y-axis). Further, a surface of thermal pad 716 may be in face sharing contact with fuse device 702. Thermal pad 716 may be positioned between fuse device 702 and cold plate 706 along a y-axis. A lower surface (e.g., with respect to the y-axis) of thermal pad 716 may be in face sharing contact with an upper (e.g., with respect to the y-axis) surface of cold plate 706. Thermal pad 716 may be a compressible pad configured to transfer thermal energy from fuse device 702 to cold plate 706. Thermal pad 716 may also provide electrical isolation between fuse device 702 and the cold plate 706. Coolant may flow through cooling chamber 704 following arrow 718. The coolant may be fluidically coupled to a liquid coolant circuit of a vehicle. In this way, a component which decreases a temperature of the coolant (e.g., a heat exchanger) of cooling system 722 may be positioned external to enclosure 724. In an alternate embodiment, a finned metal heatsink (not shown) may be coupled to thermal pad 716 and may conductively draw power (e.g., thermal energy) away from the fusing element. Cooling system 722 may operate independent of a temperature of fuse device 702 or alternatively, cooling system 722 may be partially controlled by charging interface connector 720.

Turning now to FIG. 3, a method 300 is shown for controlling a charging current or a discharging flowing through an IPCB, such as IPCB 700 of FIG. 7, using a charging interface connector of the IPCB, such as charging interface connector 720 described above with respect to FIG. 7. Method 300 may be at least partially executed by a processor of the charging interface connector and/or a controller of a DC output coupled to the IPCB. Herein, the charging current refers a magnitude of current flowing from a high voltage input to a DC output such as a vehicle (e.g., in charging direction) and discharging current refers to a magnitude of current flowing from the DC output to the high voltage input (e.g., in a discharging direction). In one example, method 300 may be at least partially executed based on instructions stored on a memory (e.g., non-transitory computer memory) of the charging interface and in conjunction with signals received from sensors of a control box, such as temperature sensors described above with reference to FIG. 7.

At 302, method 300 includes determining if charging is demanded. If charging is demanded, method 300 proceeds to 304 and includes flowing current from an energy grid (e.g., energy grid 103 to the DC output. If charging is not demanded, then discharging is demanded and method 300 proceeds to 306 and includes flowing current from the DC output to the energy grid. Following step 304 or step 306, method 300 proceeds to 308. Additionally, a third state of no charging and no discharging may be provided.

At 308, method 300 includes receiving a temperature reading from a temperature sensor. The temperature sensor may be temperature sensor 708a and/or temperature sensor 708b as described above with respect to FIG. 7. In one example, method 300 may include receiving a temperature reading from a charger side temperature sensor (e.g., temperature sensor 708a) and receiving a temperature reading from a vehicle side temperature sensor (e.g., temperature sensor 708b) and averaging the two sensor signals to provide the average temperature of a fuse device of the IPCB (e.g., fuse device 702 of FIG. 7). In another example, the system may only include temperature sensor 708a or temperature sensor 708b and utilize calibration tables stored in memory to estimate the temperature of the fuse device. In some examples, the IPCB may not include temperature sensors and receiving the temperature reading from a temperature sensor may include estimating a temperature of the fuse device based on software included in the charging interface connector, the software configured to estimate the temperature of the fuse device based on one or more operating parameters.

At 310, method 300 includes determining if the received temperature is above a threshold temperature. The threshold temperature may be a temperature above which the expected life of the fuse at a specific demanded charging current may be reduced. As one example, the demanded charging current may be 500 A which may correspond to a temperature threshold equal to 60° C. when the fuse device is a high speed fuse rated at 630 A. The temperature threshold may be determined based on equation (1) and a temperature correction factor as described in FIG. 5.

If, at 310, the received temperature is not above the threshold temperature (e.g., at or below the threshold temperature), method 300 proceeds to 312 includes maintaining or increasing the charging current or discharging current. Maintaining or increasing the charging or discharging current may include maintaining or increasing a magnitude of current flowing through the fuse device, either to or from the DC output. If the temperature is at or close to (e.g., within 5% of) the threshold temperature, the charging or discharging current may be maintained. In this way, the charging or discharging current may be maximized based on the temperature of fuse device and an overall charging time may be decreased. If, at 310, the received temperature is above the threshold temperature, method 300 proceeds to 314 to decrease the charging current or discharging current. Decreasing the charging or discharging current includes decreasing a magnitude of current flowing through the fuse device, either to or from the DC output.

Optionally, at 316, method 300 includes adjusting a cooling system of the IPCB (e.g., cooling system 722). The cooling system may be adjusted enhance cooling of the fuse device, thereby decreasing a temperature of the fuse device and allowing an increase in charging or discharging current. In one example, the cooling system may be adjusted by adjusting a flow rate of coolant through a coolant tube. As another example, adjusting the cooling system may include altering a path of the coolant such that the coolant cools only to the fuse device and not to other components of the vehicle, thereby decreasing an overall heat load on the cooling system. In this way, a temperature of the fuse device may be decreased and a current passing through the fuse device may be maintained below the threshold current. Method 300 returns to the start.

The technical effect of method 300 is that an amount of current flowing through a fuse device of an IPCB may be optimized. In this way, a charging or discharging current may be more sensitive to operating conditions of the fuse device, thereby realizing both fast charging/discharging times while also mitigating transmission of short circuit currents to a DC output. The IPCB box may protect a DC output (e.g., a vehicle) from degradation due to short-circuit currents while still allowing bi-directional current flow, both to and from the DC output. Further, the charging current may be efficiently transferred through the IPCB with low power loss.

The disclosure also provides support for a system for controlling charging of a vehicle, comprising: a charge coupler, an integrated protection control box (IPCB) electrically coupled to the charge coupler, the IPCB including, a fuse device, at least one temperature sensor for monitoring a temperature of the fuse device, a cooling system for cooling the fuse device, and a charging interface connector communicatively coupled to the at least one temperature sensor, wherein the fuse device is configured to be current limiting under a short circuit condition to mitigate an overcurrent event. In a first example of the system, the fuse device is opened when a charging current increases above a threshold current to prevent transmission of the charging current to the vehicle. In a second example of the system, optionally including the first example, a permissible current of the fuse device is increased when the fuse device is cooled by the cooling system. In a third example of the system, optionally including one or both of the first and second examples, the IPCB further includes a bus bar and the at least one temperature sensor is coupled to the bus bar. In a fourth example of the system, optionally including one or more or each of the first through third examples, the cooling system is coupled to a coolant circuit of the vehicle. In a fifth example of the system, optionally including one or more or each of the first through fourth examples, the cooling system is coupled to a finned metal heatsink. In a sixth example of the system, optionally including one or more or each of the first through fifth examples, the IPCB allows bi-directional current flow.

The disclosure also provides support for a method for controlling overcurrent events during vehicle charging, comprising: determining if charging is demanded, receiving a temperature reading from a temperature sensor coupled to a fuse device of a control box, the control box coupled to a charging device of a vehicle to mitigate transmission of a short-circuit from the charging device to the vehicle and including a charging interface connector configured to control a charging current and a discharging current, responsive to the received temperature being above a threshold temperature and demanded charging, decreasing the charging current, and in response to the received temperature being below the threshold temperature and demanded charging increasing the charging current. In a first example of the method, the temperature sensor is positioned on a charger side of the fuse device and/or a vehicle side of the fuse device. In a second example of the method, optionally including the first example, the method further comprises: in response to the received temperature being above the threshold temperature and demanded discharging, decreasing the discharging current, and in response to the received temperature being below the threshold temperature and demanded discharging, increasing the discharging current. In a third example of the method, optionally including one or both of the first and second examples, the threshold temperature is set based on an ambient temperature correction for a permissible current of the fuse device. In a fourth example of the method, optionally including one or more or each of the first through third examples, the permissible current is less than a rated current of the fuse device. In a fifth example of the method, optionally including one or more or each of the first through fourth examples, the method further comprises: in response to the received temperature being equal to the threshold temperature, maintaining the charging current. In a sixth example of the method, optionally including one or more or each of the first through fifth examples, the temperature sensor is coupled to the fuse device via a bus bar.

The disclosure also provides support for an integrated protection control box of a vehicle, comprising: a fuse device with fuse elements configured to open based on a current at a charging device coupled to the integrated protection control box, a cooling system for maintaining a temperature of the fuse device below a threshold temperature, and a charging interface connector configured to control the current at the charging device based on the temperature of the fuse device. In a first example of the system, the integrated protection control box is configured with software configured to estimate the temperature of the fuse device based on one or more operating parameters. In a second example of the system, optionally including the first example, a surface of the fuse device is in face sharing contact with a thermal pad of the cooling system. In a third example of the system, optionally including one or both of the first and second examples, a surface of the thermal pad is in face sharing contact with a cold plate of the cooling system. In a fourth example of the system, optionally including one or more or each of the first through third examples, the integrated protection control box is positioned inside an enclosure. In a fifth example of the system, optionally including one or more or each of the first through fourth examples, the cooling system includes a cooler positioned external to the enclosure.

FIG. 7 shows an example configuration with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example. It will be appreciated that one or more components referred to as being “substantially similar and/or identical” differ from one another according to manufacturing tolerances (e.g., within 1-5% deviation).

1. A system for controlling charging of a vehicle, comprising:
a charge coupler;
an integrated protection control box (IPCB) electrically coupled to the charge coupler, the IPCB including;
a fuse device;
at least one temperature sensor for monitoring a temperature of the fuse device;
a cooling system for cooling the fuse device; and
a charging interface connector communicatively coupled to the at least one temperature sensor;
wherein the fuse device is configured to be current limiting under a short circuit condition to mitigate an overcurrent event.

2. The system of claim 1, wherein the fuse device is opened when a charging current increases above a threshold current to prevent transmission of the charging current to the vehicle.

3. The system of claim 2, wherein a permissible current of the fuse device is increased when the fuse device is cooled by the cooling system.

4. The system of claim 1, wherein the IPCB further includes a bus bar and the at least one temperature sensor is coupled to the bus bar.

5. The system of claim 1, wherein the cooling system is coupled to a coolant circuit of the vehicle.

6. The system of claim 1, wherein the cooling system is coupled to a finned metal heatsink.

7. The system of claim 1, wherein the IPCB allows bi-directional current flow.

8. A method for controlling overcurrent events during vehicle charging, comprising:
determining if charging is demanded;
receiving a temperature reading from a temperature sensor coupled to a fuse device of a control box, the control box coupled to a charging device of a vehicle to mitigate transmission of a short-circuit from the charging device to the vehicle and including a charging interface connector configured to control a charging current and a discharging current;
responsive to the received temperature being above a threshold temperature and demanded charging, decreasing the charging current, and
responsive to the received temperature being below the threshold temperature and demanded charging, increasing the charging current.

9. The method of claim 8, wherein the temperature sensor is positioned on a charger side of the fuse device and/or a vehicle side of the fuse device.

10. The method of claim 8, further comprising in response to the received temperature being above the threshold temperature and demanded discharging, decreasing the discharging current, and in response to the received temperature being below the threshold temperature and demanded discharging, increasing the discharging current.

11. The method of claim 8, wherein the threshold temperature is set based on an ambient temperature correction for a permissible current of the fuse device.

12. The method of claim 11, wherein the permissible current is less than a rated current of the fuse device.

13. The method of claim 8, further comprising in response to the received temperature being equal to the threshold temperature, maintaining the charging current.

14. The method of claim 8, where the temperature sensor is coupled to the fuse device via a bus bar.

15. An integrated protection control box of a vehicle, comprising:
a fuse device with fuse elements configured to open based on a current at a charging device coupled to the integrated protection control box;
a cooling system for maintaining a temperature of the fuse device below a threshold temperature; and
a charging interface connector configured to control the current at the charging device based on the temperature of the fuse device.

16. The integrated protection control box of claim 15, wherein the integrated protection control box is configured with software configured to estimate the temperature of the fuse device based on one or more operating parameters.

17. The integrated protection control box of claim 15, wherein a surface of the fuse device is in face sharing contact with a thermal pad of the cooling system.

18. The integrated protection control box of claim 17, wherein a surface of the thermal pad is in face sharing contact with a cold plate of the cooling system.

19. The integrated protection control box of claim 15, wherein the integrated protection control box is positioned inside an enclosure.

20. The integrated protection control box of claim 19, wherein the cooling system includes a cooler positioned external to the enclosure.
